(19) United States
(12) Patent Application Publication
(10) Pub. No.: US 2026/0051958 A1
(43) Pub. Date: Feb. 19, 2026

(54) OPTICAL WIRELESS COMMUNICATION TERMINAL AND SYSTEM AND AUTOMATED POLARIZATION CONTROL METHOD

(71) Applicant: Electronics and Telecommunications Research Institute, Daejeon (KR)

(72) Inventors: Si Woong Park, Daejeon (KR); HyoungJun Park, Daejeon (KR); CHAN IL YEO, Daejeon (KR); Young Soon Heo, Daejeon (KR)

(21) Appl. No.: 19/088,861

(22) Filed: Mar. 24, 2025

(30) Foreign Application Priority Data
Aug. 13, 2024 (KR) 10-2024-0107993

(51) Int. Cl. H04B 10/532; H04B 10/112; H04B 10/572

(52) U.S. Cl. CPC H04B 10/532; H04B 10/112; H04B 10/572

(57) ABSTRACT

Provided are an optical wireless communication terminal and system and an automated polarization control (APC) method. The optical wireless communication terminal includes a transmission module configured to adjust a polarization state of transmission light; a reception module capable of receiving reception light having a variable polarization state from another optical wireless communication terminal; and a control module functionally connected to the transmission module and the reception module, wherein the control module respectively adjusts polarization states of the reception module and the transmission module according to a designated polarization control plan, such that the reception module receives the variable reception light and the transmission module transmits the adjusted transmission light.

### CROSS-REFERENCE TO RELATED APPLICATION

This application claims priority to and the benefit of Korean Patent Application No. 10-2024-0107993, filed on Aug. 13, 2024, the disclosure of which is incorporated herein by reference in its entirety.

### BACKGROUND

### 1. Field of the Invention

Various exemplary embodiments disclosed in the present document relate to an adaptive optical communication technology.

### 2. Discussion of Related Art

Optical wireless communication technology is a next-generation communication technology that transmits light signals through free space without optical fibers. Since light is utilized, optical wireless communication technology has an ultra-wide bandwidth, provides immunity to electromagnetic interference, consumes low power, and enables gigabits per second (Gbps) high-speed data transmission and long-distance (km) transmission.

Since a narrow beam of light is transmitted with strong straightness and a narrow angle of divergence, optical wireless communication is difficult to wiretap and is easily blocked by physical obstacles. Consequently, optical wireless communication systems can quickly identify physical intrusions and wiretapping attempts and have enhanced confidentiality and security.

### SUMMARY OF THE INVENTION

However, in terms of optical wireless communication systems, it may be difficult to detect wiretapping that is attempted through penetration.

The present invention is directed to providing an optical wireless communication terminal and system for enhancing optical communication security via an adaptive optical polarization state and an automated polarization control method therefor.

According to an aspect of the present invention, there is provided an optical wireless communication terminal including a transmission module configured to adjust a polarization state of transmission light; a reception module capable of receiving reception light having a variable polarization state from another optical wireless communication terminal; and a control module functionally connected to the transmission module and the reception module, wherein the control module respectively adjusts polarization states of the reception module and the transmission module according to a designated polarization control plan, such that the reception module receives the variable reception light and the transmission module transmits the adjusted transmission light.

According to another aspect of the present invention, there is provided an optical wireless communication system including a first optical wireless communication terminal capable of adjusting a polarization state of transmission light; and a second optical wireless communication terminal capable of adjusting a polarization state of reception light, wherein the first optical wireless communication terminal changes the polarization state of the transmission light by controlling a first polarization adjuster in accordance with a polarization control plan which is synchronized with the second optical wireless communication terminal and receives the reception light having a polarization state in accordance with the polarization control plan by controlling a second polarization adjuster.

According to another aspect of the present invention, there is provided an automated polarization control (APC) method of an optical wireless communication terminal, the APC method including checking a first polarization state related to transmission light of a polarization control plan which is synchronized with another optical wireless communication terminal, adjusting the transmission light correspondingly to the checked first polarization state through a first polarization adjuster, and transmitting the transmission light having the first polarization state to another optical wireless communication terminal.

### BRIEF DESCRIPTION OF THE DRAWINGS

The above and other objects, features, and advantages of the present invention will become more apparent to those of ordinary skill in the art by describing exemplary embodiments thereof in detail with reference to the accompanying drawings, in which:

FIG. 1 is a conceptual diagram of an optical wireless communication system according to an exemplary embodiment;

FIG. 2 is a configuration diagram of the optical wireless communication system according to the exemplary embodiment;

FIG. 3 is a diagram illustrating control of a multi-wavelength optical polarization state according to the exemplary embodiment;

FIG. 4 is a configuration diagram of a multi-wavelength optical wireless communication system according to another exemplary embodiment;

FIG. 5 is a flowchart of an adaptive automated polarization control (APC) method according to the exemplary embodiment; and

FIGS. 6 to 8 are diagrams illustrating polarization control plans according to the exemplary embodiment.

In relation to the description of the drawings, like reference numerals may be used for like components.

### DETAILED DESCRIPTION OF EXEMPLARY EMBODIMENTS

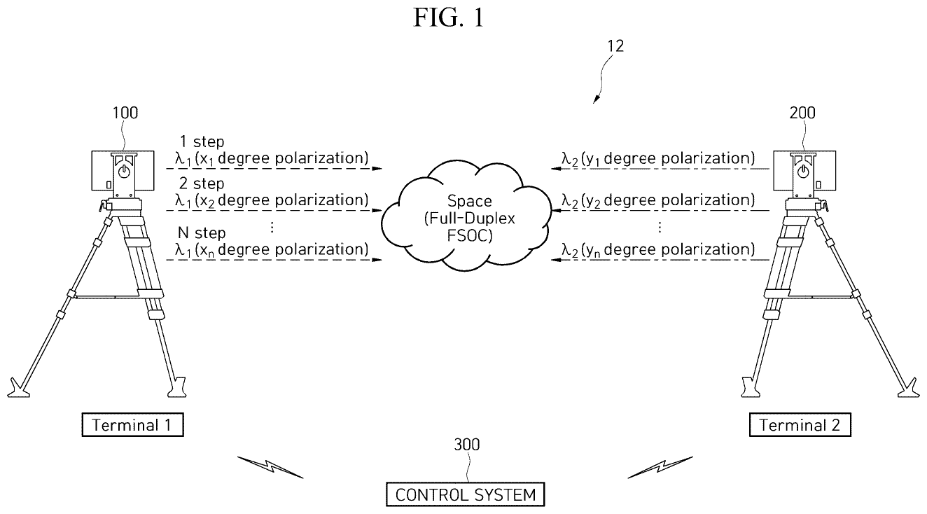

FIG. 1 is a conceptual diagram of an optical wireless communication system according to an exemplary embodiment.

Referring to FIG. 1, the optical wireless communication system 12 according to the exemplary embodiment may include a first optical wireless communication terminal 100, a second optical wireless communication terminal 200, and a control system 300.

According to the exemplary embodiment, the first optical wireless communication terminal 100 may have a first polarization adjuster related to transmission of a first light signal. In addition, the second optical wireless communication terminal 200 may have a fourth polarization adjuster related to reception of the first light signal.

The first optical wireless communication terminal 100 may adjust the first light signal using the first polarization adjuster such that the first light signal vibrates at a polarization angle in accordance with a polarization control plan (or the first light signal is in a polarization state in accordance with the polarization control plan) and may subsequently transmit the adjusted first light signal. The second optical wireless communication terminal 200 may adjust a polarization angle of the fourth polarization adjuster in accordance with the first light signal having the polarization angle of the polarization control plan and receive the first light signal that vibrates at the polarization angle in accordance with the polarization control plan (or that is in a polarization state in accordance with the polarization control plan) through the fourth polarization adjuster.

Similarly, the second optical wireless communication terminal 200 may include a third polarization adjuster related to transmission of a second light signal, and the first optical wireless communication terminal 100 may include a second polarization adjuster related to reception of the second light signal. The second optical wireless communication terminal 200 may adjust a polarization angle of the second light signal using the third polarization adjuster in accordance with the polarization control plan and transmit the adjusted second light signal. And the first optical wireless communication terminal 100 may adjust a polarization angle of the second polarization adjuster to receive the second light signal that vibrates at the polarization angle in accordance with the polarization control plan.

According to the exemplary embodiment, the first optical wireless communication terminal 100 and the second optical wireless communication terminal 200 may synchronize polarization control plans at a designated point in time (e.g., a time point of initial communication setting). For example, the first and second optical wireless communication terminals 100 and 200 may adjust the first and second polarization adjusters to an initial polarization state and transmit and receive data in the initial polarization state to synchronize the polarization control plans. The polarization control plans may include a polarization angle variation period and a polarization angle variation sequence associated with polarization states of transmission light and reception light. The variation period may be, for example, a certain interval or an interval that varies regularly. As another example, a first light signal λ₁ may be transmitted with a first polarization angle x₁, and a second light signal 2₁ may be transmitted with a second polarization angle y₁.

According to the exemplary embodiment, the first and second optical wireless communication terminals 100 and 200 may change a polarization state of at least one of transmission light and reception light in accordance with the polarization control plan in order to communicate with each other. For example, the first optical wireless communication terminal 100 may transmit the first light signal λ₁ with a first polarization angle x₁ during a first variation period, transmit the first light signal λ₁ with a second polarization angle x₂ during a second variation period, and transmit the first light signal λ₁ with a third polarization angle x₃ during a third variation period. The second optical wireless communication terminal 200 may transmit the second light signal λ₂ with a fourth polarization angle y₁ during the first variation period, transmit the second light signal λ₂ with a fifth polarization angle y₂ during the second variation period, and transmit the second light signal λ₂ with a sixth polarization angle y₃ during the third variation period. In this way, the optical wireless communication system 12 changes a polarization state of a light signal in accordance with synchronized polarization control plans, and thus it may be difficult for a wiretapper without knowledge of the polarization control plan to easily wiretap data between the first and second optical wireless communication terminals 100 and 200.

According to the exemplary embodiment, when abnormal communication between the first and second optical wireless communication terminals 100 and 200 is detected through another communication channel (e.g., a radio frequency (RF) communication channel), the control system 300 may transmit a command to change the polarization control plan. The command may include, for example, polarization control plan information to be changed. For example, when an abnormal communication state is detected, at least one communication device may report the abnormal communication state to the control system 300. Then, the control system 300 may check the abnormal communication state and transmit a command to change the polarization control plan to the first and second optical wireless communication terminals 100 and 200. The abnormal communication state may be a situation in which wiretapping of an optical communication channel is suspected, such as missing a light signal or reduced light signal intensity.

According to the exemplary embodiment, the control system 300 may communicate with the first or second optical wireless communication terminal 100 or 200 through a communication channel (e.g., RF communication) other than the optical communication channel.

According to the exemplary embodiment, the first and second optical wireless communication terminals 100 and 200 may provide a common optical path for transmission and reception light. For example, the first and second optical wireless communication terminals 100 and 200 may transmit transmission light and receive reception light through one lens unit. To this end, the first optical wireless communication terminal 100 may transmit light with a first wavelength which includes different wavelengths, and receive light with a second wavelength from the second optical wireless communication terminal 200. The first and second optical wireless communication terminals 100 and 200 may include a wavelength division multiplexing (WDM) filter and separate light with the first wavelength and light with the second wavelength passing through the common lens unit.

As described above, the optical wireless communication system 12 according to the exemplary embodiment synchronizes polarization control plans of optical wireless communication terminals and performs synchronized automated polarization control (APC). Accordingly, a light signal can be received normally only when polarization states of a transmitting side and a receiving side are exactly the same, and it is possible to improve the reliability and security of an optical wireless communication channel.

Moreover, the optical wireless communication system 12 according to the exemplary embodiment changes a polarization state regularly or irregularly in accordance with a designated polarization control plan, making it difficult for a wiretapper to know an accurate polarization state. Accordingly, it is possible to maintain the integrity of optical wireless communication data despite wiretapping based on penetration and further enhance dual security.

Further, the optical wireless communication system 12 according to the exemplary embodiment adaptively changes a polarization control plan in accordance with a situation, making it further difficult for a wiretapper to estimate polarization control.

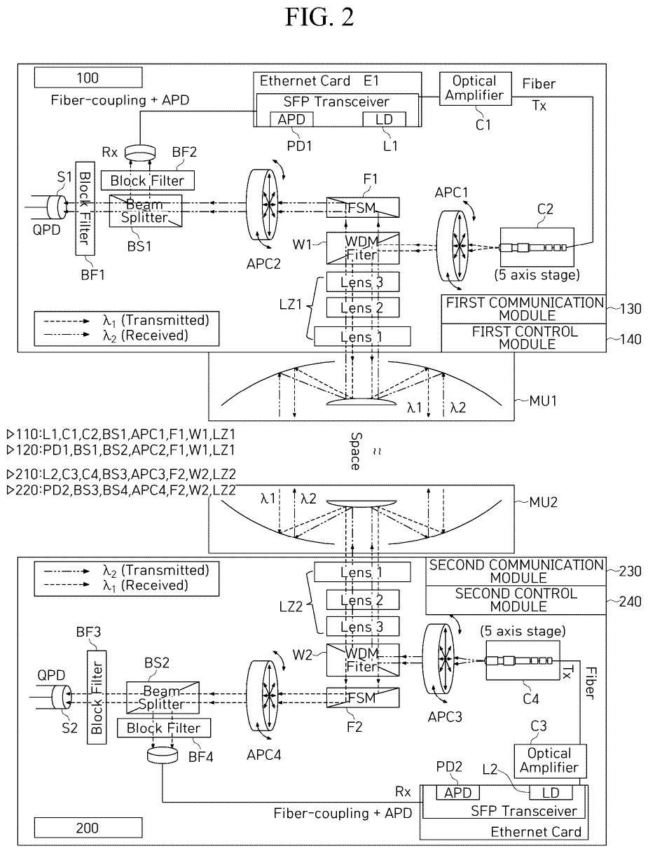

FIG. 2 is a configuration diagram of the optical wireless communication system according to the exemplary embodiment.

Referring to FIG. 2, the optical wireless communication system 12 according to the exemplary embodiment may include the first optical wireless communication terminal 100 and the second optical wireless communication terminal 200. According to the exemplary embodiment, some components of the optical wireless communication system 12 may be omitted, or additional components may be further included. In addition, some of the components of the optical wireless communication system 12 may be combined into one entity, which may perform the same functions as the components prior to the combination thereof.

According to the exemplary embodiment, the first optical wireless communication terminal 100 may include a first transmission module 110, a first reception module 120, and a first control module 140. The first transmission module 110 may include a first light source L1, a first modulator E1, a first optical amplifier C1, a first light emitter C2, and a first polarization adjuster APC1. The first reception module 120 may include a first finite state machine (FSM) F1, a first beam splitter BS1, a second polarization adjuster APC2, first and second block filters BF1 and BF2, a first optical position sensor S1, and a first light receiver PD1. A first WDM filter W1, a first lens unit LZ1, and a first mirror unit MU1 are components included in both the first transmission module 110 and the first reception module 120 and may provide the same optical path for transmission and reception. The components of the first optical wireless communication terminal 100 may be omitted, added, or integrated in accordance with applications, uses, or functions.

The first light source L1 may generate light with a first wavelength λ1. The first light source L1 may be a laser that generates laser light with the first wavelength. The first light source L1 may be embedded in, for example, a small form-factor pluggable (SFP) transceiver.

When transmission data is acquired from the first control module 140, the first modulator E1 may generate a first light signal by embedding the transmission data in light with the first wavelength using an Ethernet protocol.

The first optical amplifier C1 may amplify intensity of the first light signal modulated by the first modulator E1. The first optical amplifier C1 may be applied differently depending on a use and environment and may include one of an erbium-doped fiber amplifier (EDFA), a semiconductor optical amplifier (SOA), and a reflective semiconductor optical amplifier (RSOA).

The first light emitter C2 may emit the first light signal amplified by the first optical amplifier C1 to the first polarization adjuster APC1. For example, the first light emitter C2 may include an optical fiber connector and a motor. The first light emitter C2 may adjust a direction of the optical fiber connector in accordance with control of the first control module 140 to adjust an incident angle, an incident point, and an emission surface of light incident on the first polarization adjuster APC1. The motor may include, for example, a 5-axis stage for controlling the optical fiber connector that emits the first light signal in five axes (X, Y, Z, yaw, and pitch).

The first polarization adjuster APC1 may adjust a polarization state of the first light signal in accordance with a first control signal of the first control module 140. For example, the first control module 140 may output the first control signal to adjust a penetration polarization angle of the first polarization adjuster APC1 in accordance with the polarization control plan. The first polarization adjuster APC1 may adjust a polarization angle of the first light signal in accordance with the first control signal and pass the first light signal polarized in a designated direction in accordance with the polarization control plan. According to the exemplary embodiment, the first light signal polarized by the first polarization adjuster APC1 may be transmitted to free space through the first WDM filter W1, the first lens unit LZ1, and the first mirror unit MU1.

The first WDM filter W1 may separate light with different wavelengths. For example, the first WDM filter W1 may separate the first light signal with the first wavelength to be transmitted and a received second light signal (reception light) with a second wavelength.

The first lens unit LZ1 may include at least one lens (e.g., lens 1, lens 2, and lens 3) with one aperture and provide transmission light and reception light with a common path through the single aperture.

The first mirror unit MU1 may be provided in a Cassegrain structure to transmit the first light signal to the second optical wireless communication terminal 200 through a primary mirror and a secondary mirror. Depending on the configuration and implementation environment of the first optical wireless communication terminal 100, the first mirror unit MU1 may be replaced with another component or omitted.

The first FSM F1 may reflect the second light signal, which is transmitted by the second optical wireless communication terminal 200 and incident via the first lens unit LZ1 and the first WDM filter W1, toward the first beam splitter BS1. A reflection angle of the first FSM F1 may be changed under control of the first control module 140 for optical alignment.

The second polarization adjuster APC2 may adjust a penetration polarization angle in accordance with a second control signal of the first control module 140. For example, the first control module 140 may output the second control signal to adjust the penetration polarization angle of the second polarization adjuster APC2 in accordance with the polarization control plan. The second polarization adjuster APC2 may adjust the penetration polarization angle in accordance with the second control signal such that the second light signal with a polarization angle in accordance with the polarization control plan may be received.

The first beam splitter BS1 may split the second light signal, which is incident through the first FSM F1 and the second polarization adjuster APC2, into first tracking light and data communication light. The first tracking light is light for optical alignment and may be transmitted to the first optical position sensor S1.

The first optical position sensor S1 may include a quadrant photo diode (QPD), detect which one of quadrant spaces of the QPD the first tracking light is incident on, and output optical position information of the detection result.

The first light receiver PD1 may include an avalanche photodiode (APD) that sensitively receives data at gigabits per second (Gbps) or higher. When the data communication light is received, the first light receiver PD1 may convert the data communication light into an electrical signal. FIG. 2 illustrates a case where the first light source L1 and the first light receiver PD1 are included in an SFP receiver. However, the present invention is not limited thereto.

The first block filter BF1 may be provided at the forefront of the first optical position sensor S1, and the second block filter BF2 may be provided at the forefront of the first light receiver PD1. The first and second block filters BF1 and BF2 may block wavelengths other than the second wavelength from being incident. Depending on the configuration and application environment of the first optical wireless communication terminal 100, the first and second block filters BF1 and BF2 may be added or removed.

The first and second polarization adjusters APC1 and APC2 described above may be various forms of devices. For example, the first and second polarization adjusters APC1 and APC2 may change polarization of a light signal using a piezoelectric element or an electro-optic element. As another example, the first and second polarization adjusters APC1 and APC2 may be piezo-polarization adjusters that adjust a polarization state by transforming an optical fiber using piezoelectric effects. The first and second polarization adjusters APC1 and APC2 may be electro-optic polarization adjusters that change a polarization state using an electric field. The first and second polarization adjusters APC1 and APC2 may be mechanical polarization adjusters that adjust a polarization state by distorting or bending an optical fiber.

The first control module 140 may control at least one other component (e.g., hardware or software component) of the first optical wireless communication terminal 100 and perform various data processing or computations. The first control module 140 may include, for example, at least one of a central processing unit (CPU), a graphics processing unit (GPU), a microprocessor, an application processor, an application-specific integrated circuit (ASIC), and a field programmable gate array (FPGA) and may have a plurality of cores.

The first control module 140 may perform optical alignment to maximize fiber-coupling efficiency of the first light receiver PD1 when the second light signal receives at the center of the first optical position sensor S1 prior to optical wireless communication. For example, the first control module 140 may acquire optical position information of the second light signal received from the first optical position sensor S1. The first control module 140 may perform precise optical alignment within a small range by adjusting the reflection angle of the first FSM F1 on the basis of the acquired optical position information. The first control module 140 may perform fiber coupling through the precise control of the first FSM F1 such that maximum intensity may be incident on the first light receiver PD1.

According to the exemplary embodiment, the first control module 140 may set the first and second polarization adjusters APC1 and APC2 to an initial polarization state at a designated point in time (e.g., a time point of initial communication setting). The initial polarization state may be a default polarization state of the first and second optical wireless communication terminals 100 and 200. When data related to polarization control plans is transmitted to and received from the second optical wireless communication terminal 200 in the initial polarization state, the first control module 140 may set in synchronization a polarization control plan. The polarization control plan may include at least one of a variation period and a variation sequence associated with polarization states (or polarization angles of the first and second polarization adjusters APC1 and APC2) of the first light signal and the second light signal. The variation period may be a certain interval or an interval that varies regularly. The variation sequence may include, for example, the order of setting polarization angles of the first and second polarization adjusters APC1 and APC2 or polarization angles to be sequentially set.

The first control module 140 may adjust a polarization state of transmission light through the first polarization adjuster APC1 in accordance with a designated polarization control plan. For example, the first control module 140 may monitor whether there is a variation period associated with a polarization state of the transmission light in accordance with the designated polarization control plan and may check a polarization state of the transmission light to be currently designated (or the polarization angle of the first polarization adjuster APC1) when it is determined to be the variation period. The first control module 140 may transmit a first control signal to the first polarization adjuster APC1 to set the polarization state (or polarization angle) as checked.

Similarly, the first control module 140 may (selectively) receive the second light signal having a polarization state in accordance with the polarization control plan through the second polarization adjuster APC2. For example, the first control module 140 may monitor whether there is a variation period associated with a reception polarization state in accordance with the designated polarization control plan and may check a reception polarization state to be currently designated (or the polarization angle of the second polarization adjuster APC2) when it is determined to be the variation period. The first control module 140 may transmit a second control signal to the second polarization adjuster APC2 to set the polarization state (or polarization angle) as checked.

The first control module 140 may monitor whether the optical communication is abnormal on the basis of a detection result of at least one of the first light receiver PD1 and the first optical position sensor S1. For example, in at least one of the case where the first optical position sensor S1 detects a positional change of the second light signal and the case where the first light receiver PD1 detects an intensity change of the second light signal, the first control module 140 may determine that it is an abnormal communication state (e.g., an abnormal communication environment or the occurrence of wiretapping). When it is determined to be an abnormal communication state, the first control module 140 may share the abnormal communication state with the second optical wireless communication terminal 200 and the control system 300.

The first control module 140 may receive a command to change the polarization control plan from the control system 300 through another communication channel (e.g., an RF communication channel). In this regard, the first optical wireless communication terminal 100 may further include another communication module for RF communication. For example, the control system 300 may check an abnormal communication state of at least one terminal on the basis of data of at least one of the first and second optical wireless communication terminals 100 and 200 or through its own monitoring. In this case, the control system 300 may transmit a command to change a polarization control plan to the first and second optical wireless communication terminals 100 and 200. Accordingly, the first control module 140 may receive the command to change a polarization control plan from the control system 300.

When the command to change a polarization control plan is received, the first control module 140 may extract a polarization control plan to be changed from the change command. Subsequently, the first control module 140 may update the polarization control plan to be changed in a memory and then control the first and second polarization adjusters APC1 and APC2 on the basis of the updated polarization control plan.

According to the exemplary embodiment, the second optical wireless communication terminal 200 may include a second transmission module 210, a second reception module 220, and a second control module 240. The second transmission module 210 may include a second light source L2, a second modulator E2, a second optical amplifier C3, a second light emitter C4, and a third polarization adjuster APC3. The second reception module 220 may include a second FSM F2, a second beam splitter BS2, a fourth polarization adjuster APC4, third and fourth block filters BF3 and BF4, a second optical position sensor S2, and a second light receiver PD2. A second WDM filter W2, a second lens unit LZ2, and a second mirror unit MU2 are components included in both the second transmission module 210 and the second reception module 220 and may provide the same optical path for transmission and reception. The components of the second optical wireless communication terminal 200 may be omitted, added, or integrated in accordance with applications, uses, or functions. Since the second optical wireless communication terminal 200 transmits the second light signal and receives the first light signal according to the exemplary embodiment, a configuration relevant thereto is partially different from that of the first optical wireless communication terminal 100. Therefore, the third and fourth polarization adjusters APC3 and APC 4 will be mainly described, and other detailed descriptions will be omitted.

The second control module 240 may perform optical alignment to maximize fiber-coupling efficiency of the second light receiver PD2 when the first light signal receives at the center of the second optical position sensor S2 prior to communication with the first optical wireless communication terminal 100. For example, the second control module 240 may acquire optical position information of the first light signal from the second optical position sensor S2. The second control module 240 may perform precise optical alignment associated with the first optical wireless communication terminal 100 within a small range by adjusting a reflection angle of the second FSM F2 on the basis of the acquired optical position information. The second control module 240 may perform fiber coupling through the precise control of the second FSM F2 such that the maximum intensity may be incident on the second light receiver PD2.

According to the exemplary embodiment, the second control module 240 may set the third and fourth polarization adjusters APC3 and APC4 to an initial polarization state at a designated point in time (e.g., a time point of initial communication setting). The initial polarization state may be a default polarization state of the second optical wireless communication terminal 200. When data related to polarization control plans is transmitted to and received from the first optical wireless communication terminal 100 in the initial polarization state, the second control module 240 may set a polarization control plan in synchronization thereof. The polarization control plan may include at least one of a variation period and a variation sequence associated with polarization states (or polarization angles of the third and fourth polarization adjusters APC3 and APC4) of the first light signal and the second light signal. The variation period may be a certain interval or an interval that varies regularly.

The second control module 240 may adjust a polarization state of the second light signal through the third polarization adjuster APC3 in accordance with a designated polarization control plan. For example, the second control module 240 may monitor whether there is a variation period associated with a transmission polarization state in accordance with the designated polarization control plan and may check a transmission polarization state to be currently designated (or the polarization angle of the third polarization adjuster APC3) when it is determined to be the variation period. The second control module 240 may transmit a third control signal to the third polarization adjuster APC3 to set the polarization state (or polarization angle) as checked.

Similarly, the second control module 240 may receive the first light signal having a polarization state in accordance with the polarization control plan through the fourth polarization adjuster APC4. For example, the second control module 240 may monitor whether there is a variation period associated with a polarization state of the first light signal in accordance with the designated polarization control plan and may check a reception polarization state to be currently designated (or the polarization angle of the fourth polarization adjuster APC4) when it is determined that there is the variation period. The second control module 240 may transmit a fourth control signal to the fourth polarization adjuster APC4 to set the polarization state (or polarization angle) as checked.

The second control module 240 may monitor whether the optical communication is abnormal on the basis of a detection result of at least one of the second light receiver PD2 and the second optical position sensor S2. For example, in at least one of the case where the second optical position sensor S2 detects a positional change of the first light signal and the case where the second light receiver PD2 detects an intensity change of the first light signal, the second control module 240 may determine that it is an abnormal communication state (e.g., an abnormal communication environment or the occurrence of wiretapping). When it is determined to be an abnormal communication state, the second control module 240 may share the abnormal communication state with the first optical wireless communication terminal 100 and the control system 300. Alternatively, the second control module 240 may check an abnormal communication state on the basis of data received from the first optical wireless communication terminal 100.

The second control module 240 may receive a command to change the polarization control plan from the control system 300 through another communication channel (e.g., an RF communication channel). In this regard, the second optical wireless communication terminal 200 may further include another communication module for RF communication. For example, when the control system 300 detects that there is an abnormal communication state through at least one of the first and second optical wireless communication terminals 100 and 200 or its own monitoring, the control system 300 may transmit a command to change a polarization control plan to the second optical wireless communication terminal 200. Accordingly, the second control module 240 may receive the command to change a polarization control plan from the control system 300.

When the command to change a polarization control plan is received, the second control module 240 may identify a polarization control plan to be changed from the change command. Subsequently, the second control module 240 may update the identified polarization control plan in a memory and then control the third and fourth polarization adjusters APC3 and APC4 on the basis of the updated polarization control plan.

In the above-described embodiment, it is necessary to set the first polarization adjuster APC1 in the first optical wireless communication terminal 100 and the fourth polarization adjuster APC4 in the second optical wireless communication terminal 200 to have the same polarization angle. Likewise, it is necessary to set the second polarization adjuster APC2 in the first optical wireless communication terminal 100 and the third polarization adjuster APC3 in the second optical wireless communication terminal 200 to have the same polarization angle.

As described above, the first and second optical wireless communication terminals 100 and 200 according to the exemplary embodiment synchronize polarization control plans and perform synchronized APC. Accordingly, a light signal can be received normally only when polarization states of a transmitting side and a receiving side are exactly the same, and it is possible to improve the reliability and security of an optical wireless communication channel.

In addition, the first and second optical wireless communication terminals 100 and 200 according to the exemplary embodiment change a polarization state regularly or irregularly in accordance with a designated polarization control plan, making it difficult for a wiretapper to know an accurate polarization state. Accordingly, it is possible to further enhance dual security by enhancing the security of physical layers and maintain the integrity of optical wireless communication data despite wiretapping based on penetration thereof.

Further, the optical wireless communication system 12 according to the exemplary embodiment adaptively changes a polarization control plan in accordance with a situation, making it further difficult for a wiretapper to estimate polarization control.

Moreover, the first and second optical wireless communication terminals 100 and 200 according to the exemplary embodiment may serve as beacons for tracking and full-duplex data communication through the structure of the optical wireless communication system based on a common optical path. Accordingly, it is possible to continuously perform precise optical alignment and tracking on the basis of optical communication signals without using an additional subsystem for building an optical alignment link.

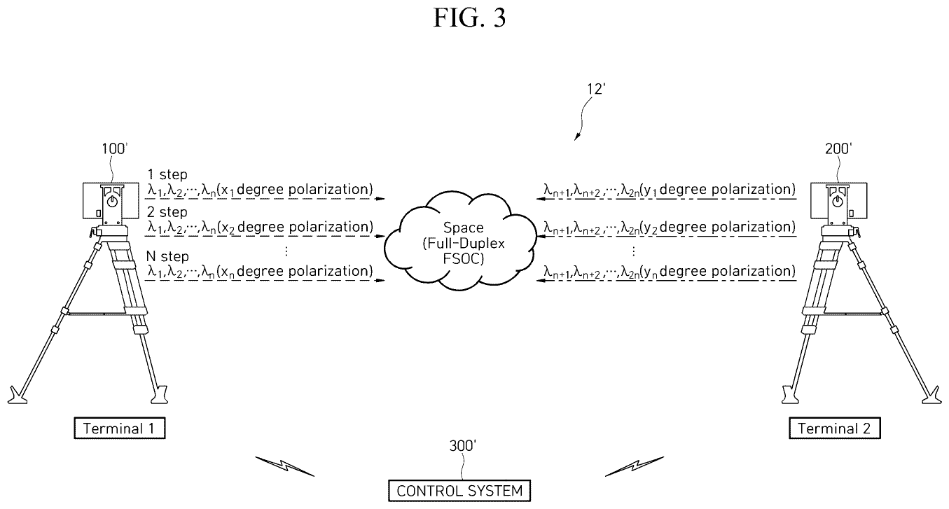

FIG. 3 is a diagram illustrating control of a multi-wavelength optical polarization state according to the exemplary embodiment.

Referring to FIG. 3, a first multi-wavelength optical wireless communication terminal 100′ may transmit a first multi-wavelength (λ₁, λ₂, . . . , and λₙ) light signal, and a second multi-wavelength optical wireless communication terminal 200′ may transmit a second multi-wavelength (λₙ₊₁, λₙ₊₂, . . . , and λ₂ₙ) light signal.

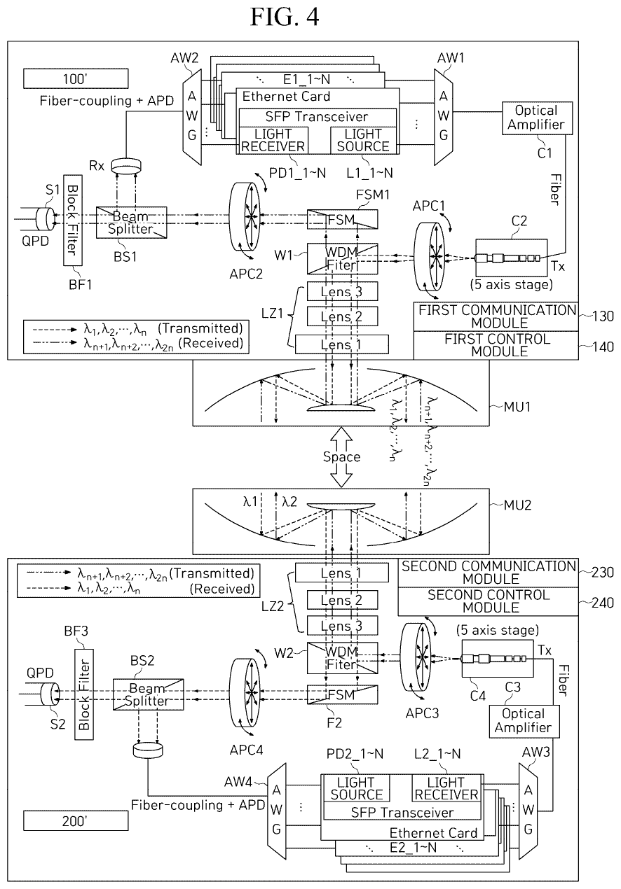

FIG. 4 is a configuration diagram of a multi-wavelength optical wireless communication system according to another exemplary embodiment.

Referring to FIG. 4, a multi-wavelength optical wireless communication system 12′ according to the other exemplary embodiment may include a first multi-wavelength optical wireless communication terminal 100′ and a second multi-wavelength optical wireless communication terminal 200'. According to the other exemplary embodiment, some components of the multi-wavelength optical wireless communication system 12′ may be omitted, or additional components may be further included. In addition, some of the components of the multi-wavelength optical wireless communication system 12′ may be combined into one entity, which may perform the same functions as the components prior to the combination. The multi-wavelength optical wireless communication system 12′ is partially different from the single-wavelength optical wireless communication system 12 according to the exemplary embodiment in that multi-wavelength light is transmitted and received. Accordingly, the difference will be mainly described in FIGS. 3 and 4.

The first multi-wavelength optical wireless communication terminal 100′ according to the other exemplary embodiment is partially different from the exemplary embodiment in that it includes a plurality of first light sources L1_1 to L1_N, a plurality of first modulators E1_1 to E1_N, a first arrayed waveguide grating (AWG) AW1, a second AWG AW2, and a plurality of first light receivers PD1_1 to PD1_N. In addition, the second multi-wavelength optical wireless communication terminal 200′ is partially different from the exemplary embodiment in that it includes a plurality of second light sources L2_1 to L2_N, a plurality of second modulators E2_1 to E2_N, a third AWG AW3, a fourth AWG AW4, and a plurality of second light receivers PD2_1 to PD2_N.

The plurality of first light sources L1_1 to L1_N may generate light with first to N^{th} wavelengths λ₁ to λ_{N}, respectively. The plurality of first modulators E1_1 to E1_N may embed transmission data in light with the first to N^{th} wavelengths and modulate the light in accordance with a designated standard (Ethernet data standard) to generate first to N^{th} light signals, respectively. The first AWG AW1 may send the first to N^{th} light signals to arrayed waveguides and combine the first to N^{th} light signals in one optical fiber to generate a multiplexed first multi-wavelength signal. The first multi-wavelength signal output from the first AWG AW1 may go through a first optical amplifier C1, a first light emitter C2, a first polarization adjuster APC1, a first WDM filter W1, a first lens unit LZ1, and a first mirror unit MU1 and may be transmitted to the second multi-wavelength optical wireless communication terminal 200′ through free space. The first multi-wavelength signal may be incident on the fourth AWG AW4 through a second lens unit LZ2, a second WDM filter W2, a fourth polarization adjuster APC4, and a second beam splitter BS2 of the second multi-wavelength optical wireless communication terminal 200′. When the first multi-wavelength signal is incident on one optical fiber, the fourth AWG AW4 may split the first multi-wavelength signal by wavelength through arrayed waveguides and output the split signals through arrayed optical fibers. The split first to N^{th} light signals may be transmitted to the plurality of second light receivers PD2_1 to PD2_N. The plurality of second light receivers PD2_1 to PD2_N may acquire first to N^{th} light signals based on an Ethernet standard by electrically converting the first to N^{th} light signals. The plurality of modulators E2_1 to E2_N may convert the first to N^{th} light signals based on the Ethernet standard into a form that is interpretable by a second control module 240.

Similarly, when the second multi-wavelength optical wireless communication terminal 200′ transmits light signals with (N+1)^{th} to 2N^{th} wavelengths λ_{N+1} to λ_{2N}, the first multi-wavelength optical wireless communication terminal 100′ may receive the light signals with (N+1)^{th} to 2N^{th} wavelengths λ_{N+1} to λ_{2N}.

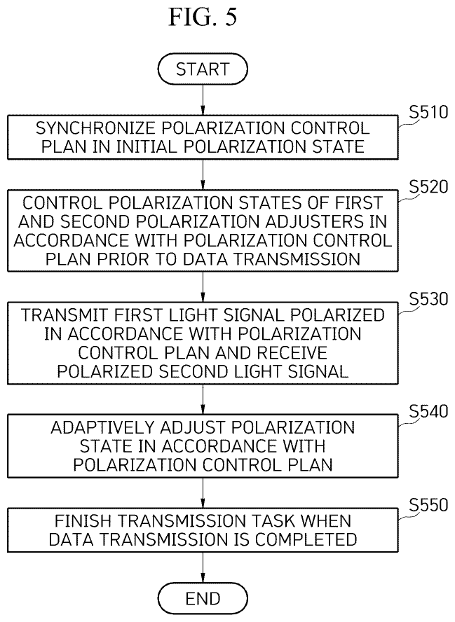

FIG. 5 is a flowchart of an adaptive APC method according to the exemplary embodiment. FIG. 5 illustrates a case where the first optical wireless communication terminal 100 transmits data and the second optical wireless communication terminal 200 receives the data.

Referring to FIG. 5, in operation 510, the first optical wireless communication terminal 100 and the second optical wireless communication terminal 200 may synchronize polarization control plans upon setting initial communication. For example, the first and second optical wireless communication terminal 100 and 200 may set the first and fourth polarization adjusters APC1 and APC4 to an initial polarization state and transmit and receive data to and from each other in the initial polarization state, thereby synchronizing polarization control plans. In this regard, the second optical wireless communication terminal 200 may identify a time point of initial communication setting through the control system 300.

In operation 520, the first optical wireless communication terminal 100 may prepare transmission data and transmit first and second control signals related to polarization state control to the first and second polarization adjusters APC1 and APC2, thereby adjusting a polarization state in accordance with the synchronized polarization control plan. Data transmission and reception may be performed in a full-duplex manner such that data transmission and reception may be simultaneously performed. Accordingly, during the polarization state control of the first optical wireless communication terminal 100, the second optical wireless communication terminal 200 may also perform polarization state control.

In operation 530, the first optical wireless communication terminal 100 transmits a first light signal that passes through a set polarization angle of the first polarization adjuster APC1. The second polarization adjuster APC2 of the first optical wireless communication terminal 100 is set to have a polarization angle in accordance with the polarization control plan. Accordingly, when a polarization state of a second light signal received from the second optical wireless communication terminal 200 is the same as a polarization angle of the second polarization adjuster APC2, data can be received. Otherwise, when the polarization state of the second light signal is not the same as the polarization angle of the second polarization adjuster APC2, data can be blocked.

In operation 540, the first optical wireless communication terminal 100 may update the polarization states of the first and second polarization adjusters APC1 and APC2 regularly or irregularly in accordance with the polarization control plan. In addition, when an environmental change is detected, the first optical wireless communication terminal 100 adaptively readjusts the polarization states of the first and second polarization adjusters APC1 and APC2 to block external wiretapping and improve the security of an optical wireless communication link.

In operation 550, when it is determined that data transmission has been completed, the first optical wireless communication terminal 100 may finish transmission of the first light signal.

As described above, the optical wireless communication system 12 according to the exemplary embodiment can set a polarization state regularly or irregularly in accordance with adaptive APC scheduling to meet a user's requirements and can provide an additional physical security layer through a mechanism that enhances the security of an optical wireless communication link doubly by adaptively readjusting a polarization state when a change in the usual environment or an external wiretapping element is detected through environmental change detection.

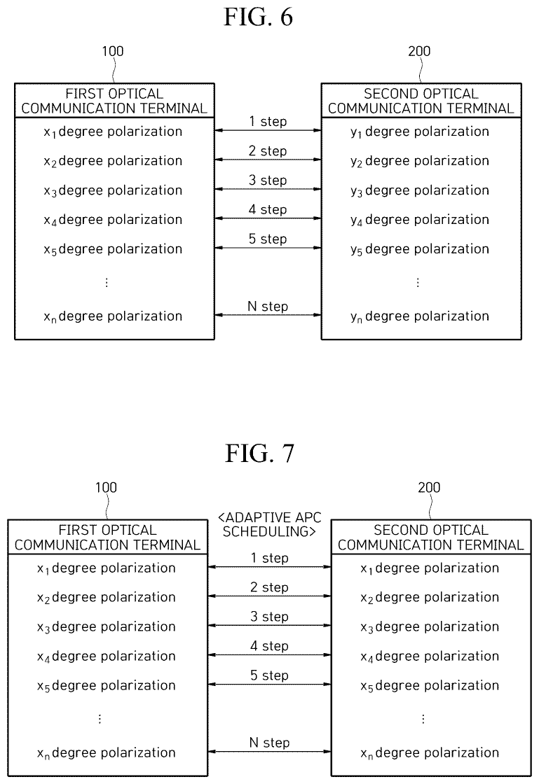

FIGS. 6 to 8 are diagrams illustrating polarization control plans according to the exemplary embodiment. According to the exemplary embodiment, it is necessary to set the first polarization adjuster APC1 in the first optical wireless communication terminal 100 and the fourth polarization adjuster APC4 in the second optical wireless communication terminal 200 to have the same polarization angle. Likewise, it is necessary to set the second polarization adjuster APC2 in the first optical wireless communication terminal 100 and the third polarization adjuster APC3 in the second optical wireless communication terminal 200 to have the same polarization angle.

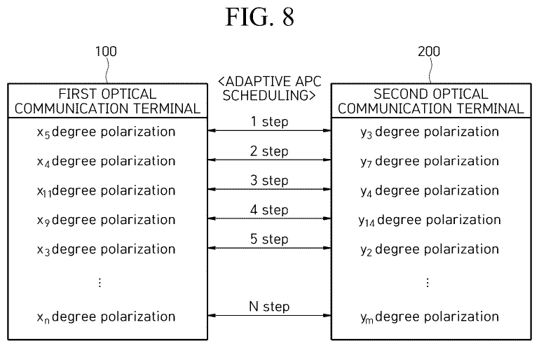

As shown in FIG. 6, the polarization angles of the first and second optical wireless communication terminals 100 and 200 may be set on a one-to-one basis (xₙ:yₙ) (n is constant). As shown in FIG. 7, the polarization angles of the first and second optical wireless communication terminals 100 and 200 may be set to be identical to each other (xₙ:xₙ). As shown in FIG. 8, the polarization angles of the first and second optical wireless communication terminals 100 and 200 may be set randomly (xₙ:yₘ) (n and m are random constants).

As described above, the optical wireless communication system 12 according to the exemplary embodiment can diversify and sophisticate adaptive APC scheduling (polarization control plans) by regularly or irregularly learning a pattern of a user's requirements and an operating environment. Accordingly, it is possible to ensure the integrity and confidentiality of transmission data.

Various embodiments of the present document and terms used therein are not intended to limit technical characteristics described in the present document to specific embodiments, and it should be understood that the present document includes various modifications, equivalents, or substitutions of the embodiments. In description of drawings, similar reference numerals may be used for similar or associated components. A singular form of a noun corresponding to an item may include one or more items unless the context clearly indicates otherwise. In the present document, expressions such as “A or B,” “at least one of A and B,” “at least one of A or B,” “A, B, or C,” “at least one of A, B, and C” and “at least one of A, B, or C” may include any one of or all possible combinations of items listed together in one of the corresponding expressions. Terms such as “1^{st},” “2^{nd},” “first,” “second,” etc. may be used to simply distinguish a corresponding component from another and do not limit the components in another aspect (e.g., importance or order). When a certain (e.g., first) component is referred to, with or without the term “functionally” or “communicatively,” as “coupled” or “connected” to another (e.g., second) component, it means that the certain component may be coupled with the other component directly (e.g., by wire), wirelessly, or via a third component.

As used herein, the term “module” may include a unit implemented in hardware, software, or firmware and may interchangeably be used with other terms, such as “logic,” “logic block,” “part,” and “circuit. ” A module may be a single integral component or a minimal unit or part thereof that performs one or more functions. For example, according to an embodiment, a module may be implemented in the form of an ASIC.

Various embodiments of the present document may be implemented as software (e.g., a program) including one or more instructions that are stored in a storage medium (e.g., an internal memory or an external memory) that is readable by a machine (e.g., an optical wireless communication terminal). For example, a processor (e.g., the first control module 140 of FIG. 2) of a device ((e.g., an optical wireless communication terminal (e.g., the first optical wireless communication terminal 100 of FIG. 2)) may invoke at least one of the one or more stored instructions from the storage medium and execute the at least one invoked instruction. This allows the machine to be operated to perform at least one function in accordance with the at least one invoked instruction. The one or more instructions may include code generated by a compiler or code executable by an interpreter. The machine-readable storage medium may be provided in the form of a non-transitory storage medium. Here, the term “non-transitory” simply means that the storage medium is a tangible device and does not include a signal (e.g., an electromagnetic wave), but this term does not distinguish between a case where data is semi-permanently stored in the storage medium and a case where data is temporarily stored in the storage medium.

According to an embodiment, methods according to various embodiments set forth herein may be included and provided in a computer program product. The computer program product may be traded as a product between a seller and buyer. The computer program product may be distributed in the form of a machine-readable storage medium (e.g., a compact disc (CD) read-only memory (ROM)) or distributed (e.g., downloaded or uploaded) online via an application store (e.g., PlayStore™) or between two user devices (e.g., smartphones) directly. When distributed online, at least a part of the computer program product may be temporarily generated or at least temporarily stored in a machine-readable storage medium such as a memory of the manufacturer's server, an application store server, or a relay server.

Components according to various embodiments of the present document may be implemented in the form of software or hardware, such as a digital signal processor (DSP), an FPGA, or an ASIC and perform certain roles. The term “components” is not limited to software or hardware, and each component may be configured to be in an addressable storage medium or to reproduce one or more processors. Examples of components may include components, such as software components, object-oriented software components, class components, and task components, processes, functions, attributes, procedures, subroutines, segments of a program code, drivers, firmware, microcode, circuits, data, databases, data structures, tables, arrays, and variables.

According to various embodiments, each (e.g., a module or a program) of the foregoing components may include a single entity or a plurality of entities. According to various embodiments, one or more of the foregoing components or operations may be omitted, or one or more other components or operations may be added. Alternatively or additionally, a plurality of components (e.g., modules or programs) may be integrated into a single component. In such a case, the integrated component may still perform one or more functions of each of the plurality of components in the same manner as or a similar manner to a corresponding one of the plurality of components prior to the integration. According to various embodiments, operations performed by a module, a program, or another component may be carried out sequentially, in parallel, repeatedly, or heuristically, one or more of the operations may be executed in a different order or omitted, or one or more other operations may be added.

According to various embodiments disclosed in the present document, it is possible to enhance security of optical communication due to an adaptive optical polarization state. In addition, various effects that are directly or indirectly understood from the present document can be provided.

What is claimed is:

1. An optical wireless communication terminal comprising:
a transmission module configured to adjust a polarization state of transmission light;
a reception module capable of receiving reception light having a variable polarization state from another optical wireless communication terminal; and
a control module functionally connected to the transmission module and the reception module,
wherein
the control module respectively adjusts polarization states of the reception module and the transmission module according to a designated polarization control plan, such that the reception module receives the variable reception light and the transmission module transmits the adjusted transmission light.

2. The optical wireless communication terminal of claim 1, wherein the control module sets the transmission module and the reception module to an initial polarization state, and
transmits and receives data related to synchronization of the polarization control plan to and from the other optical wireless communication terminal using the transmission module and the reception module in the initial polarization state to designate the polarization control plan.

3. The optical wireless communication terminal of claim 1, wherein the transmission module comprises:
a light source configured to generate the transmission light;
an optical fiber connector configured to emit the transmission light; and
a first polarization adjuster configured to adjust the polarization state of the transmission light in accordance with the polarization control plan.

4. The optical wireless communication terminal of claim 1, wherein the transmission light and the reception light have different wavelengths, and
the optical wireless communication terminal further comprises:
a wavelength-division multiplexing (WDM) filter configured to separate wavelengths of the transmission light and the reception light; and
a lens unit configured to provide a common optical path to the transmission light that has passed through the WDM filter and the reception light to be incident on the WDM filter.

5. The optical wireless communication terminal of claim 4, wherein the reception module comprises:
a finite state machine (FSM) configured to reflect the reception light that has passed through the WDM filter at a designated angle;
a second polarization adjuster configured to adjust a polarization angle corresponding to the reception light such that the reception light having the polarization state in accordance with the polarization control plan is received through the FSM;
a beam splitter configured to split the transmitted reception light into tracking light and data communication light;
a light receiver configured to receive the data communication light; and
a position detection sensor configured to detect a position of the tracking light.

6. The optical wireless communication terminal of claim 1, wherein, when the transmission light is first multi-wavelength light and the reception light is second multi-wavelength light, the transmission module and the reception module comprise at least a part of an arrayed waveguide grating (AWG) configured to multiplex the first multi-wavelength light into one ray of light and split the second multi-wavelength light into individual wavelengths.

7. The optical wireless communication terminal of claim 1, wherein the polarization control plan includes at least one of a variation period and a variation sequence associated with the polarization states.

8. The optical wireless communication terminal of claim 7, wherein the variation period is set to a certain interval or an interval that varies regularly.

9. The optical wireless communication terminal of claim 1, further comprising a communication module configured to communicate with a control center device using another communication method,
wherein the control module changes the polarization control plan in accordance with a control command of the control center device received through the communication module.

10. The optical wireless communication terminal of claim 9, wherein the control command is transmitted when the control center device detects abnormal communication with the control module or the other optical wireless communication terminal.

11. A optical wireless communication system comprising:
a first optical wireless communication terminal capable of adjusting a polarization state of transmission light; and
a second optical wireless communication terminal capable of adjusting a polarization state of reception light,
wherein the first optical wireless communication terminal changes the polarization state of the transmission light by controlling a first polarization adjuster in accordance with a polarization control plan which is synchronized with the second optical wireless communication terminal and receives the reception light having a polarization state in accordance with the polarization control plan by controlling a second polarization adjuster.

12. The optical wireless communication system of claim 11, further comprising a control center device configured to communicate with at least one communication terminal of the first optical wireless communication terminal and the second optical wireless communication terminal through another communication channel,
wherein, when an abnormal communication state of the at least one communication terminal is identified, the control center device transmits a command to change the polarization control plan to the first optical wireless communication terminal and the second optical wireless communication terminal.

13. The optical wireless communication system of claim 11, wherein the first optical wireless communication terminal sets the first polarization adjuster and the second polarization adjuster to an initial polarization state and transmits and receives data related to synchronization of the polarization control plan to and from the second optical wireless communication terminal in the initial polarization state to designate the polarization control plan.

14. The optical wireless communication system of claim 11, wherein the polarization control plan includes at least one of a variation period and a variation sequence associated with polarization states.

15. The optical wireless communication system of claim 14, wherein the variation period is set to a certain interval or an interval that varies regularly.

16. An automated polarization control (APC) method of a first optical wireless communication terminal, the APC method comprising:
checking a first polarization state related to transmission light of a polarization control plan which is synchronized with a second optical wireless communication terminal;
adjusting the transmission light to the checked first polarization state through a first polarization adjuster; and
transmitting the transmission light having the first polarization state to the second optical wireless communication terminal.

17. The APC method of claim 16, further comprising:
checking a second polarization state related to reception light of the polarization control plan;
adjusting a polarization angle of a second polarization adjuster to receive the reception light having the checked second polarization state; and
receiving the reception light in the second polarization state from the second optical wireless communication terminal through the second polarization adjuster.

18. The APC method of claim 17, further comprising:
setting the first polarization adjuster and the second polarization adjuster to an initial polarization state; and
communicating with the second optical wireless communication terminal using the first polarization adjuster and the second polarization adjuster in the initial polarization state to set the polarization control plan in synchronization with the second optical wireless communication terminal.

19. The APC method of claim 16, further comprising, when an abnormal communication state of at least one of the first optical wireless communication terminal and the second optical wireless communication terminal is checked through another communication channel, transmitting a command to change the polarization control plan to the first optical wireless communication terminal and the second optical wireless communication terminal.

20. The APC method of claim 16, wherein the polarization control plan includes at least one of a variation period and a variation sequence associated with the first polarization state, and
the variation period is set to a certain interval or an interval that varies regularly.
